(19) United States
(12) Patent Application Publication
(10) Pub. No.: US 2024/0410731 A1
(43) Pub. Date: Dec. 12, 2024

(54) SENSOR FOR MEASURING A MASS FLOW RATE

(71) Applicant: Endress+Hauser Flowtec AG, Reinach (CH)

(72) Inventors: Benjamin Schwenter, Ettingen (CH); Christian Schütze, Basel (CH); Marc Werner, Grenzach-Wyhlen (DE); Ennio Bitto, Aesch (CH); Dieter Mundschin, Liestal (CH)

(21) Appl. No.: 18/690,356

(22) PCT Filed: Aug. 10, 2022
(86) PCT No.: PCT/EP2022/072438

§ 371 Date: Mar. 8, 2024

(30) Foreign Application Priority Data
Sep. 9, 2021 (DE) 10 2021 123 415.8

(51) Int. Cl. G01F 1/84

(52) U.S. Cl. CPC G01F 1/8472

(57) ABSTRACT

A vibronic sensor for measuring mass flow rate, includes a measurement pipe, an excitation magnet and a sensor magnet, an excitation coil and a sensor coils, each having an elongated basic shape. The basic shape has a center of gravity through which a largest diameter having a length d₁ and a smallest diameter having a length d₂ extend, wherein the excitation coil or the sensor coil has a first coil axis and a second coil axis in a cross-sectional plane. The largest diameter d is in the first coil axis, wherein the smallest diameter d₂ is in the second coil axis. For a quotient d₁/d₂, the following applies: 1.15≤d₁/d₂, where, when the measurement pipe vibrates in an in-plane mode, a deflection direction of the measurement pipe is oriented in parallel with the first coil axis in a region of the excitation magnet or the sensor magnet.

The present invention relates to a sensor for measuring a mass flow rate with a single measurement pipe.

Generic sensors are described, for example, in the published patent application DE 039 16 285 A1, publication EP 518 124 A1 and the as yet unpublished patent application DE 10 2015 122 146.2. Sensors with a single measurement pipe are advantageous in that they do not contain any flow dividers. Unlike sensors having two measurement pipes which vibrate symmetrically relative to one another, however, it is more difficult in the case of sensors having only a single measurement pipe to avoid an interaction with the surroundings by decoupling vibrational energy of a bending vibration use mode or by coupling interfering vibrations from the surroundings. To this end, publication DE 10 2010 030 340 A1 discloses a sensor with a single measurement pipe, in which the measurement pipe has two parallel-guided loops which vibrate relative to one another and thus balance one another. For this type of sensor, however, due to the course of the measurement pipe in loops, a discharge capability of the measurement pipe is in principle excluded, while sensors of the generic type can basically be designed to be dischargeable.

As a contribution to avoiding interaction with the surroundings by decoupling vibration energy in a bending vibration use mode or by coupling interfering vibrations from the surroundings, EP 518 124 A1 describes a frequency separation between the vibrations of the measurement pipe and vibrations of other components of the sensor.

WO 2018/219603 A1 discloses a vibronic sensor having precisely one S-shaped measurement pipe which is connected to a support plate which is resiliently mounted against the sensor housing. With such vibronic sensors, the measurement pipe may still experience fault modes, especially during transportation or in the event of faulty installation of the sensor, which can lead to collisions between coils and magnets of the vibration sensors and/or vibration exciters.

The object of the invention is to remedy this problem.

The object is achieved according to the invention by the vibronic sensor according to independent claim 1.

The vibronic sensor according to the invention for measuring the mass flow rate of a flowable medium comprises:
a line inlet section;
a line outlet section;
a measurement pipe capable of vibrating for conducting the medium,
   wherein the measurement pipe in its rest position is bent in a pipeline plane,
   wherein the measurement pipe on the inlet side connects to the line inlet section and on the outlet side to the line outlet section and can be connected via the latter to a pipeline;
at least one vibration exciter for exciting bending vibrations of the measurement pipe in a bending vibration mode;
at least two vibration sensors for detecting vibrations of the measurement pipe,
   wherein the at least one vibration exciter comprises an excitation coil and/or wherein the at least two vibration sensors each comprise a sensor coil,
   wherein the at least one vibration exciter comprises an excitation magnet and/or wherein the at least two vibration sensors each comprise a sensor magnet, wherein the excitation magnet and/or the sensor magnet is arranged on the measurement pipe,
   wherein the excitation magnet extends through a coil opening of the excitation coil and/or
   wherein the sensor magnet extends through a coil opening of the sensor coil,
   wherein the excitation coil and/or the sensor coil has an elongated basic shape,
   wherein the basic shape has a center of gravity through which a largest diameter having a length d₁ and a smallest diameter having a length d₂ extend,
   wherein the excitation coil and/or the sensor coil has a first coil axis and a second coil axis in a cross-sectional plane,
   wherein the largest diameter d is in the first coil axis,
   wherein the smallest diameter d2 is in the second coil axis,
   wherein, for a quotient d₁/d₂, the following applies: 1.15≤d₁/d₂ especially 1.5≤d1/d2 and preferably 2≤d₁/d₂,
   wherein the measurement pipe is designed in such a way that, when the measurement pipe vibrates in an, especially smallest, in-plane mode, a deflection direction of the measurement pipe is oriented in parallel with the first coil axis in a region of the excitation magnet and/or the sensor magnet; and
a sensor housing,
   wherein the line inlet section and the line outlet section are each firmly connected to the sensor housing.

The advantage of the embodiment is that a variable spacing between the excitation magnet and the excitation coils and/or between the at least one sensor magnet and the corresponding sensor coil is thus achieved. The consequence of this is that in the event of certain fault modes, a collision between the coil and the magnet moving in the coil opening is prevented. This is advantageous particularly in the case of magnets which are immersed in the coil opening of the coil or are enclosed at least in sections by the coil.

Advantageous embodiment of the invention are the subject matter of the dependent claims.

One embodiment provides that the following applies for the quotient d₁d₂:d₁/d₂≤10, especially d₁/d₂≤7.5 and preferably d₁/d₂≤3.

One embodiment provides for the excitation magnet and/or the sensor magnet to have a magnet diameter with a length d_{M},
wherein the length of the magnet diameter d_{M} is smaller than the length d₂ of the smallest diameter,
wherein, for a quotient d₂/d_{M}, the following applies: 1<d₂/d_{M}≤2, especially 1.2≤d₂/d_{M}≤1.8 and preferably 1.3≤d₂/d_{M}≤1.4.

In the simplest case, the diameter of the round coil opening can be increased in order to achieve the stated object. However, this simultaneously also increases the spacing between magnet and coil in regions which are not affected by parasitic vibration modes, which leads to a reduced measuring sensitivity. The two above-mentioned embodiments have the advantage that the spacing between magnet and coil is as small as possible-as a result of which a high measuring sensitivity is achieved-with the magnet at the same time being able to vibrate without collision.

One embodiment provides for the measurement pipe to have a profile that is S-shaped at least in sections,
wherein a longitudinal axis exists in the pipe plane, to which the pipe axis has at no point an angle of more than 85°, especially no more than 83°.

The advantage of this embodiment is that, in case of a vertical orientation of the longitudinal direction of the sensor relative to the gravitational direction, emptying of the measurement pipe is ensured.

One embodiment provides for the first coil axis to intersect the longitudinal axis at an angle α, wherein angle α has an angular dimension of 0° to 15°, especially 4° to 10°, and preferably 6° to 8°.

It has been found that for such configurations having an S-shaped measurement pipe, a collision-free vibration of the magnets can be ensured also in case of parasitic vibration modes of less than 1000 Hz.

One embodiment comprises:
a support system having a support plate at least one bearing body on the inlet side and at least one bearing body on the outlet side,
   wherein the support system has support system vibration modes comprising elastic deformations of the support plate,
   wherein the measurement pipe is firmly connected to the support plate by means of the bearing body on the inlet side and by means of the bearing body on the outlet side, and is bordered by the bearing bodies.

One embodiment provides for a connection axis to connect the at least one inlet-side bearing body and the at least one outlet-side bearing body,
wherein the first coil axis intersects the connection axis at an angle β,
wherein angle β has an angular dimension of 0° to 30°, especially 4° to 20°, and preferably 6° to 10°.

Especially in the case of sensors having a support system—comprising a support plate and two bearing bodies—the probability that defects occur because of collisions between magnet and coils is reduced due to the angular range according to the invention of angle β.

One embodiment provides for the measurement pipe to have two outer straight sections and a central straight section between the two bearing bodies, which sections are connected by two arc-shaped sections,
wherein the two bearing bodies are each arranged on the outer straight sections.

One embodiment provides for the natural frequencies of the degrees of translational vibration freedom and degrees of rotational vibration freedom of the support plate to be not less than 100 Hz, especially not less than 150 Hz, and/or not less than 200 Hz.

One embodiment provides for the largest diameter to be selected such that, when the measurement pipe vibrates in the lowest in-plane mode, the excitation magnet vibrates without collision in the coil opening of the excitation coil and/or the sensor magnet vibrates without collision in the coil opening of the sensor coil.

One embodiment provides for the lowest in-plane mode to be in a frequency range of less than 1000 Hz, especially less than 300 Hz.

The invention is explained in greater detail with reference to the following figures. In the figures:

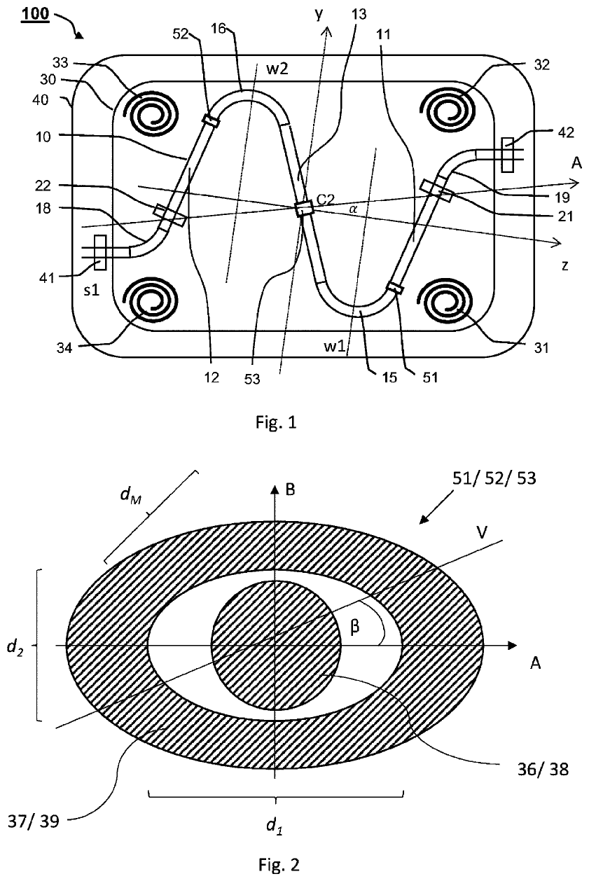

FIG. 1 shows an embodiment of the vibronic sensor according to the invention; and

FIG. 2 shows a cross section through the vibration exciter or vibration sensor.

The sensor 100 comprises a measurement pipe 10 having a first straight external section 11, a second straight external section 12, and a central straight section 13, as well as a first bent section 15 and a second bent section 16. The two straight external segments 15, 16 are each connected to the central straight section 13 by means of one of the bent sections 15, 16. This results in a profile of the measurement pipe 10 that is S-shaped at least in sections. The measurement pipe 10 is bordered by exactly two bearing bodies 21, 22 and fastened to the latter on a rigid support plate 30.

The measurement pipe 10 capable of vibrating runs essentially in a pipe plane parallel to the support plate 30. The measurement pipe 10 has a two-fold rotational symmetry about an axis of symmetry which runs perpendicular to the pipe plane through a point C2 in the center of the central pipe section. The measurement pipe 10 has an internal diameter of 5 mm or less, for example. It is made of a metal, in particular stainless steel or titanium. The metallic support plate 30 has a thickness of 5 mm, for example. The support plate 30 has four spiral spring-loaded bearings 31, 32, 32, 33, 34, which in particular are cut out by means of a laser, and which likewise have the two-fold rotational symmetry relative to each other with respect to the axis of symmetry through the point C2. The support plate 30 is anchored to a housing plate 40 of a sensor housing by way of bearing bolts, not shown here, which are fixed in the center of the spring-loaded bearings.

The support system has support system vibration modes comprising elastic deformations of the support plate 30. The natural frequencies of the degrees of translational vibration freedom and degrees of rotational vibration freedom of the support plate 30 are not less than 100 Hz, especially not less than 150 Hz, and/or not less than 200 Hz. Moreover, the lowest in-plane mode is in a frequency range of greater than 1000 Hz.

The spring bearings 31, 32, 33, 34 avoid resonant vibrations with vibrations of up to 50 Hz which frequently occur in process plants. In order not to impair the soft suspension of the support plate achieved by the spring-loaded bearings 31, 32, 33, 34, the measurement pipe can be connected to a pipeline via a sufficiently soft line inlet section 18 and a sufficiently soft line outlet section 19. The housing has first and second housing bearings 41 42, which are firmly connected to the housing plate 40 and to which the line inlet section 18 and the line outlet section 19 are fixed in order to suppress transmission of vibrations of the pipeline to the measurement pipe via the line inlet section 18 and the line outlet section 19. The degrees of translational and rotational vibration freedom of the support plate 30 each have natural frequencies fᵢ which are proportional to the root of a quotient comprising a benchmark kᵢ and an idleness term mᵢ, i.e., f₁∝(kᵢ/mᵢ)^{1/2}. In sum, the line inlet section 18 and the line outlet section contribute not more than 10% to the respective benchmark kᵢ. In FIG. 1, the line inlet section 18 and the line outlet section 19 are shown substantially schematically.

As further illustrated in FIG. 1, the sensor 100 has a first electrodynamic vibration sensor 51 and a second electrodynamic vibration sensor 52 for detecting the vibrations of the measurement pipe. In this case, the two vibration sensors 51, 52 are each arranged on one of the two straight external sections 11, 12 no more than a radius of curvature of the bent sections 15, 16 from the adjacent bent section. In order to excite bending vibrations, especially F3 bending vibrations, the sensor has an electrodynamic vibration exciter 53 which is arranged in the center C2 of the two-fold rotational symmetry and acts in the direction of the axis of symmetry. The vibration sensors 51, 52 each have a sensor magnet arranged on the measurement pipe 10. The vibration exciter 53 has an excitation magnet, which is also arranged on the measurement pipe 10, and an elongated excitation coil. The excitation coil can be fastened to a holding device which is connected to the support plate 30. The excitation coil has a first coil axis A, which runs through the largest diameter. The excitation coil is arranged in such a way that the first coil axis A intersects the longitudinal axis Z of the measurement pipe 10 at an angle α, wherein angle α has an angular dimension of 0° to 15°, especially 4° to 10°, and preferably 6° to 8°. The sensor coils can also have an elongated basic shape and fulfill the orientation condition of the excitation coil relative to the longitudinal axis Z. The excitation coil and/or the sensor coil usually comprise a wound coil wire which has an insulating coating. In addition, the excitation coil and/or the sensor coil can have an especially electrically insulating coil body which is designed in such a way that the magnet can also collide therewith. This is also prevented by the solution according to the invention.

The center C2 is the origin of a coordinate system for describing further aspects of the invention. The measurement pipe 10 lies in a y-z plane, wherein the y axis runs parallel to angle bisectors w1, w2, which each extend between a pipe axis of the straight external segments 11, 12 and the pipe axis of the central straight section 13. The z axis runs perpendicular to the y axis in the pipe plane and defines a longitudinal axis of the sensor 100. At no point does the longitudinal axis Z have an angle of more than 85°, especially more than 83°, to the pipe axis. When said longitudinal axis is arranged perpendicularly, the sensor can be emptied optimally. The inclination of the straight sections is then equal to half the angle between a pipe axis of the straight external sections 11, 12 and the pipe axis of the central straight section 13. In the preferred exemplary embodiment of the invention, this inclination is 7°. The measurement pipe 10 is designed in such a way that, when the measurement pipe 10 vibrates in an, especially smallest, in-plane mode, a deflection direction of the measurement pipe 10 is oriented in parallel with the first coil axis A in a region of the excitation magnet and/or the sensor magnet.

FIG. 2 shows a cross-section through the at least one vibration exciter 53 or through a vibration sensor of the at least two vibration sensors 51, 52. The at least one vibration exciter 53 comprises an excitation coil 37 and an excitation magnet 36. The excitation magnet 36 is arranged on the measurement pipe. The vibration sensors 51, 52 each comprise a sensor coil 39 and a sensor magnet 38. The sensor magnet 38 is also arranged on the measurement pipe. The embodiments mentioned below can relate in each case to the sensor coils and the sensor magnets and/or to the excitation coil and the excitation magnet. Therefore, “coil” is used hereinafter in lieu of sensor coil or excitation coil, and “magnet” is used in lieu of sensor magnet or excitation magnet.

The magnet extends through a coil opening of the coil. The coil opening has an elongated basic shape, especially a rounded convex basic shape with a center of gravity through which a largest diameter having a length d₁ and a smallest diameter having a length d₂ run. The coil has a first coil axis A and a second coil axis B in a cross-sectional plane. The largest diameter d₁ is in the first coil axis A and the smallest diameter d₂ is in the second coil axis B. The respective diameters are selected such that, for a quotient d₁/d₂, the following applies: 1.15≤d₁/d₂, especially 1.5≤d₁/d₂ and preferably 2≤d₁/d₂, and further d₁/d₂≤10, especially d₁/d₂≤7.5 and preferably d₁/d₂≤3. According to the embodiment shown, the first coil axis A runs orthogonally to the second coil axis B. The magnet has a magnet diameter with a length d_{M}. The length of the magnet diameter d_{M} is smaller than the length d₂ of the smallest diameter; especially, the diameters are selected such that the following applies for a quotient d₂/d_{M}: 1<d₂/d_{M}≤2, especially 1.2≤d₂/d_{M}≤1.8 and preferably 1.3≤d₂/d_{M}≤1.4. The vibration sensor and/or the vibration exciter is arranged on a sensor with a support system having a support plate, at least one bearing body on the inlet side and at least one bearing body on the outlet side, see FIG. 1. The coil is arranged on the measurement pipe in such a way that a connection axis V—which connects the at least one bearing body on the inlet side and the at least one bearing body on the outlet side—and the first coil axis A intersect at an angle β. Angle β advantageously has an angular dimension of 0° to 30°, especially 4° to 20°, and preferably 6° to 10°.

1-11. (canceled)

12. A vibronic sensor for measuring the mass flow rate of a flowable medium, comprising:
a line inlet section;
a line outlet section;
a measurement pipe capable of vibrating for conducting the medium,
wherein the measurement pipe in its rest position is bent in a pipeline plane,
wherein the measurement pipe on the inlet side connects to the line inlet section and on the outlet side to the line outlet section and can be connected via the latter to a pipeline;
at least one vibration exciter for exciting bending vibrations of the measurement pipe in a bending vibration mode;
at least two vibration sensors for detecting vibrations of the measurement pipe,
wherein the at least one vibration exciter comprises an excitation coil and/or wherein the at least two vibration sensors each comprise a sensor coil,
wherein the at least one vibration exciter comprises an excitation magnet and/or wherein the at least two vibration sensors each comprise a sensor magnet,
wherein the excitation magnet and/or the sensor magnet is arranged on the measurement pipe,
wherein the excitation magnet extends through a coil opening of the excitation coil and/or
wherein the sensor magnet extends through a coil opening of the sensor coil,
wherein the coil opening has an elongated basic shape,
wherein the basic shape has a center of gravity through which a largest diameter having a length d₁ and a smallest diameter having a length d₂ extend,
wherein the excitation coil and/or the sensor coil has a first coil axis and a second coil axis in a cross-sectional plane,
wherein the largest diameter d₁ is in the first coil axis,
wherein the smallest diameter d₂ is in the second coil axis,
wherein, for a quotient d₁/d₂, the following applies: 1.15≤d₁/d₂
wherein the measurement pipe is designed in such a way that, when the measurement pipe vibrates in an, especially smallest, in-plane mode, a deflection direction of the measurement pipe is oriented in parallel with the first coil axis in a region of the excitation magnet and/or the sensor magnet; and
a sensor housing,
wherein the line inlet section and the line outlet section are each firmly connected to the sensor housing.

13. The sensor according to claim 12,
wherein the following applies for the quotient d₁/d₂:d₁/d₂≤10.

14. The sensor according to claim 13,
wherein the excitation magnet or the sensor magnet has a magnet diameter with a length
wherein the length of the magnet diameter d_{M} is smaller than the length d₂ of the smallest diameter,
wherein, for a quotient d₂/d_{M}, the following applies: 1<d₂/d_{M}≤2.

15. The sensor according to claim 12,
wherein the measurement pipe has a profile that is S-shaped at least in sections,
wherein a longitudinal axis exists in the pipe plane, to which the pipe axis has at no point an angle of more than 85°.

16. The sensor according to claim 15,
wherein the first coil axis intersects the longitudinal axis at an angle α,
wherein angle α has an angular dimension of 0° to 15°.

17. The sensor according to claim 12, comprising:
a support system having a support plate, at least one inlet-side bearing body and at least one outlet-side bearing body,
wherein the support system has support system vibration modes comprising elastic deformations of the support plate,
wherein the measurement pipe is firmly connected to the support plate by means of the bearing body on the inlet side and by means of the bearing body on the outlet side, and is bordered by the bearing bodies.

18. The sensor according to claim 17,
wherein a connection axis connects the at least one inlet-side bearing body and the at least one outlet-side bearing body,
wherein the first coil axis intersects the connection axis at an angle β,
wherein angle β has an angular dimension of 0° to 30°.

19. The sensor according to claim 17,
wherein the measurement pipe between the two bearing bodies has two external straight sections and a central straight section, which are connected by two arc-shaped sections,
wherein the two bearing bodies are each arranged on the outer straight sections.

20. The sensor according to claim 17,
wherein the natural frequencies of the degrees of translational vibration freedom and degrees of rotational vibration freedom of the support plate are not less than 100 Hz.

21. The sensor according to claim 12,
wherein the largest diameter is selected such that, when the measurement pipe vibrates in the lowest in-plane mode, the excitation magnet vibrates without collision in the coil opening of the excitation coil and/or the sensor magnet vibrates without collision in the coil opening of the sensor coil.

22. The sensor according to claim 12,
wherein the lowest in-plane mode is in a frequency range of less than 1000 Hz.
